(19) United States
(12) Patent Application Publication
(10) Pub. No.: US 2012/0217396 A1
(43) Pub. Date: Aug. 30, 2012

(54) FLEXIBLE AND CONVENIENT IR EMITTER DEVICE

(75) Inventor: John Michael Demskie, Prior Lake, MN (US)

(73) Assignee: Remote Technologies, Inc., Shakopee, MN (US)

(21) Appl. No.: 13/034,401

(22) Filed: Feb. 24, 2011

(51) Int. Cl. G01J 5/00

(52) U.S. Cl. 250/338.1; 250/493.1

(57) ABSTRACT

Added functionality and convenience is provided for integrator of automation systems due to the design of an IR emitter component that can be easily positioned in front of IR receivers, while also being IR transparent. The IR emitter component includes a holder designed for easy attachment to many different surfaces. The holder is also configured for removably coupling to an IR emitter device, thus allowing the holder to remain attached to the related component. The IR emitter component is also IR transparent, thus allowing additional IR signals to be passed through the device.

### FIELD OF THE INVENTION

The present invention is generally related to components used in automated control systems. More specifically, the present invention generally relates to a convenient infrared (IR) emitter which is relatively easy to install and troubleshoot, which produces IR Signals and allows IR signals to be transmitted through the device.

### BACKGROUND OF THE INVENTION

General automation systems are becoming more and more prevalent in homes, office buildings, schools, hotels and many other facilities. Typical present day automation systems provide the coordinated control of audiovisual systems, lighting systems, appliances, communication systems, heating and/or cooling systems, etc. For example, it is not uncommon for residential structures to have audiovisual systems which provide music and/or programming to multiple locations throughout the structure. A coordinated heating/cooling system could also be included to thus allow programmed control of the building temperature through the same system. Modern classrooms utilize multimedia/audio/visual equipment on a regular basis. Similarly, office buildings often have the need for audiovisual systems in conference rooms which provide media management, in addition to data communications capabilities. Further, entertainment programming could likewise be distributed, with multimedia programming being provided to many rooms by a central system.

Remote controls are widely utilized in many of the above-mentioned control systems. This generally includes both hand-held remote controls, and remote controls which are mounted or fixed at certain locations. As is well known, a wall-mounted remote control can easily incorporate the same functionality provided by a hand-held remote. In many cases, this functionality includes wireless communication with other systems, even though the remote control is mounted to a wall.

In typical applications, remote control devices transmit control signals via infrared (IR) communication techniques. Most automation equipment includes infrared receivers (IR receivers) specifically designed to receive these signals from hand-held devices. In certain specialized applications, the remote control devices may also transmit via radio frequency (rf) signals. While rf signals produce several advantages, specialized equipment is typically required to receive and process these signals. As mentioned above, most controlled components (e.g. audio-visual equipment, home control equipment, thermostats, etc.) include IR receivers specifically designed to receive infrared signals. To exploit the advantages of rf communication, while continuing to use IR controlled equipment, some systems will include rf receivers, and the capability to translate the information into IR signals. Consequently, the use of IR communication techniques provides convenience when setting up and installing an automated system.

As is well understood, the use of infrared signals requires line of sight communication capabilities. Consequently, if control components are to be enclosed within cabinets or specialized housings, the use of infrared communication is not ideal. To solve these problems, various techniques are used. In one approach, an IR receiver is placed in a conspicuous location and electrically connected to related equipment. Signals received are then reproduced by the related equipment and transmitted to appropriate devices. Typically, the IR signal is reproduced using an IR emitter, which can be positioned/mounted wherever necessary.

IR emitters are typically installed directly upon the IR receiver of the equipment to be controlled. In some cases, the surfaces of these receivers (or receiver windows) are somewhat irregular, thus creating attachment challenges. In other instances, the IR emitter will completely cover the IR receiver, which may not be desirable. Further, troubleshooting can become a challenge when the IR emitter has been attached to the IR receiver, and operating problems have been discovered. These are all typical challenges that an installer or professional integrator must deal with when using IR emitters. (In the following description, reference will be made to an integrator, with the understanding that this includes any individual or individuals involved with installing automated systems).

As can be anticipated, it is highly desirable to have a convenient device to allow infrared signals to be presented to infrared controlled equipment from multiple sources. Such a device should be easy to install and troubleshoot, while also providing additional features that enhance operation.

### SUMMARY OF THE INVENTION

The present invention provides a flexible IR device emitter which addresses many of the complications involved with installation. The IR emitter device includes an emitter component which is contained within a housing, with the housing being specifically configured to be coupled with a holder. The holder itself includes features designed to conveniently attach the device to most surfaces, including devices with curved, contoured or irregular surfaces. The housing and holder are detachable from one another, thus providing for the easy removal of the IR emitter component (and housing) during troubleshooting. Using a separate holder which continues to be attached to the controlled device via an adhesive, allows the holder to remain in place and avoids the removal of adhesives.

In addition to the features outlined above, the IR emitter component and all related electrical components are attached to an IR transparent circuit board. Consequently, IR signals are thus allowed to pass through the device. Further, the circuit board includes an LED flasher to provide feedback to an integrator during installation.

### BRIEF DESCRIPTION OF THE DRAWINGS

Further advantages of the present invention can be seen from reading the following detailed description of the preferred embodiments, in conjunction with the drawings in which:

FIG. 1 is an exemplary system diagram illustrating various components of an overall automation system;

FIG. 2 is a schematic diagram illustrating the components carried by a circuit board within the IR emitter device;

FIG. 3 is a front view illustrating one embodiment of the holder and the IR emitter housing;

FIG. 4 is an exploded view of the holder, circuit board and components making up the IR emitter device; and

FIG. 5 is a front view of the holder alone.

### DETAILED DESCRIPTION OF THE PREFERRED EMBODIMENTS

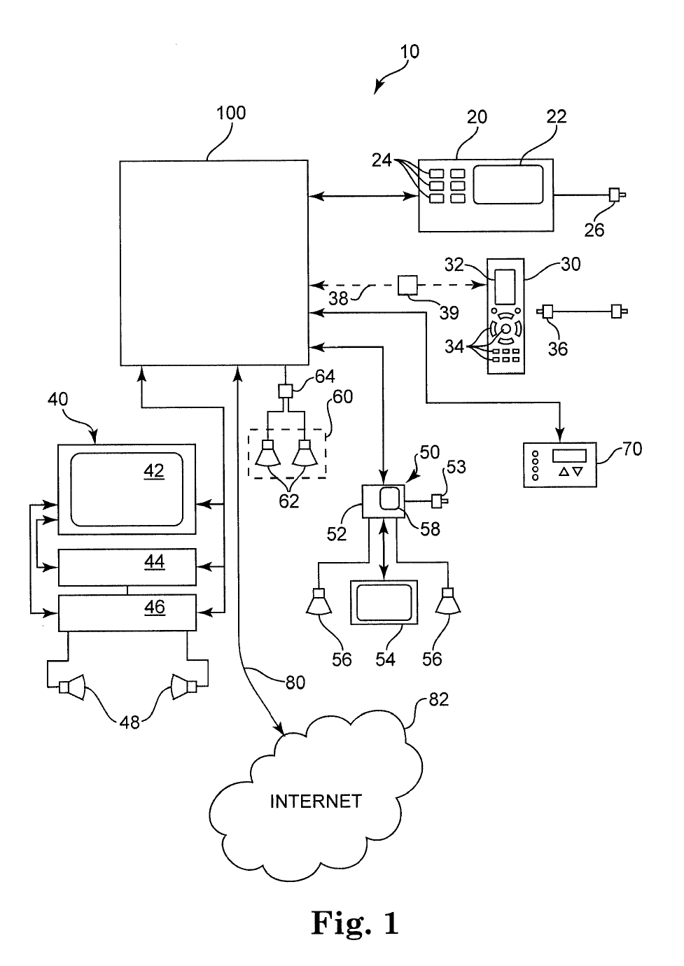

As mentioned above, the present invention relates to a common component having many different applications within an automation system. Referring now to FIG. 1, an exemplary automation control system 10 is generally illustrated. In this system, various components are shown for purposes of illustrating the overall context of the present invention. A central component of automation control system 10 is a control processor 100 which includes multiple input and output ports. Each of these ports provide for flexible communication capabilities with various components.

In communication with control processor 100 are a wall-mounted remote 20, a hand-held remote 30, an audiovisual entertainment system 40, a second entertainment system 50, a pair of speakers 60, a thermostat 70, and an input/output connection 80 coupled to a network 82. Any of these components could possibly include IR communication components (i.e., IR receivers and/or IR transmitters). As suggested above, control processor 100 includes a microprocessor or microcontroller capable of coordinating operation of the entire automation control system 10. In the process of coordinating this overall central control processor 100 will necessarily be required to communicate with certain controlled devices via the devices IR receiver ports.

Referring again to FIG. 1, it can be seen where the multiple inputs and outputs of control processor 100 are necessary and beneficial. In this particular embodiment, it is anticipated that communication components could take various formats, with each being optimally configured for overall operation of automation control system 10. For example, wall-mounted remote control 20 could easily be hard-wired to control processor 100, or, could communicate via rf communication signals. Also, it is contemplated that hand-held remote 30 could communicate via infrared (IR) signals, as is typically utilized by remote controls. Communication could also take place via rf signals, thus providing more versatility and not requiring line of sight communication (i.e., signals can be passed through walls and doors, etc.). Naturally, this requires appropriate rf transmitter and receiver components.

Referring now to second entertainment system 50, illustrated in FIG. 1. It is contemplated that this system would include a subsystem controller 52 which operates in conjunction with a display 54 and a pair of speakers 56. In this particular embodiment, subsystem controller 52 includes an interface 58 which is made up of a touch screen display. Generally speaking, subsystem controller 52 could coordinate the operation of second entertainment system 50, while operating as a subsystem when coordinating with control processor 100. In the operation subsystem controller 52, it is further anticipated that IR communication will be required.

In this system, wall-mounted remote 20, hand-held remote 30 and subsystem controller 52 are all components in communication with control processor 100. To eventually communicate signals to other controlled components, it is anticipated that control processor 100 will utilize IR emitters in multiple locations. As such, this allows control processor 100 to both receive and transmit information to and from these devices, and others similarly situated on the system.

Referring now to some of the other systems illustrated in FIG. 1, AV entertainment system 40, generally includes a monitor or display 42, a video disc player 44 and an audio amplifier 46. Connected to the outputs from audio amplifier 46 is a pair of speakers 48. As can be anticipated, these components all combine to provide a relatively well understood and straightforward home entertainment system. Naturally, additional or alternative components may also be included. More specifically, many of these components are controlled using IR signals.

Lastly, illustrated in FIG. 1 is an input/output (I/O) connection 80 for communication with a network 82. In this particular embodiment, it is contemplated that this would provide connection between control processor 100 and any type of network including a Local Area Network (LAN), private network, an intranet, the Internet or World Wide Web. Naturally, this may also include connections to networks provided within the facility or complex, or any other type of network connection.

As the system illustration of FIG. 1 highlights, there are many different communication needs when attempting to install an integrated control system. One recurring communication methodology utilizes infrared (IR) communication signals. This is primarily due to the fact that multiple components include integrated infrared receivers designed to cooperate with hand-held remote controls. The most common example again is the typical television or stereo system. Such infrared control (and specifically IR receivers) are also potentially integrated into multiple similar devices such as thermostats and related home automation equipment.

As generally illustrated above, control processor 100 assumes overall control for multiple devices. Consequently, there is a need for control processor 100 to reproduce infrared signals and communicate them to appropriate components. One well accepted methodology for achieving this communication technique is by using an IR emitter which receives electrical signals from control processor 100 (or any system or IR driver) and produces corresponding infrared signals. When in use for automation purposes, an IR emitter is positioned appropriately to pass this IR signal directly to the necessary component. In many cases, the IR emitter is physically placed directly in front of the component's IR receiver, thus providing an efficient and straightforward line of sight for signal communications.

For the professional integrator, several complications and concerns may be encountered, when placing these IR emitters as mentioned above. In some instances, it is desired that the IR emitter provide exclusive control for the related component. In other instances, however, it is desired to utilize a dual control approach, with the IR emitter and the existing remote control both providing the capability for producing control signals. Additionally, integrators must deal with potential faulty components or unexpected system issues (which unfortunately are encountered from time to time). When dealing with these complications, it is often necessary to test or troubleshoot individual components or systems before the installation is complete. Alternatively, it may be necessary to remove components after they have been installed, which may require the need to remove and restring or rerun wires throughout various locations. As can be imagined, this is undesirable.

In order to provide an IR emitter which is more convenient for the installer, the preferred embodiment includes a transparent IR emitter contained within a uniquely designed housing, and a holder which allows for easy attachment to related components. The holder itself can be easily attached to the desired components and is designed to hold the emitter housing as necessary. Consequently, if an emitter is determined to be faulty, the integrator simply removes the emitter housing from the holder without having to remove the holder itself. In the past, the integrator would need to remove an entire IR emitter housing which was typically attached using adhesives. Here, only the holder is attached using adhesives.

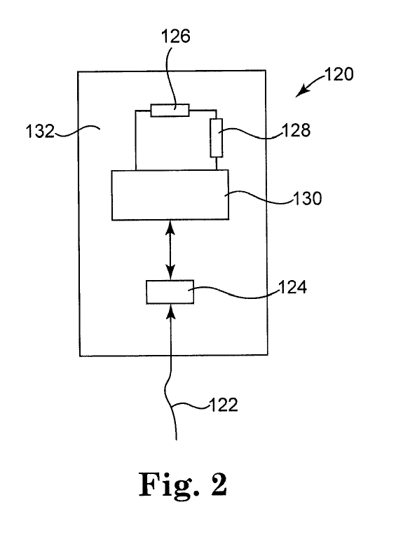

In order to further describe the features and characteristics of the IR emitter, FIGS. 2 through 5 illustrate various details of one embodiment of the present invention. Referring now to FIG. 2, a schematic block diagram shows the various components carried by a circuit board 132 and situated within an IR emitter device 120. As generally discussed above, a cable 122 is attached to IR emitter device 120 to provide necessary control signals from related devices. In most common applications, these control signals will originate from a system controller or some type of overall control device. The signals presented by cable 122 are received by an integrated resistor 124 utilized to protect other components/circuitry from voltage overdrive. Received signals are then transferred to an IR emitter component 130. As is well understood, voltage applied to the IR emitter component 130 will cause the emitter to be energized thus producing infrared signals. These infrared signals are then emitted from IR emitter component 130 and can be focused or directed towards desired components/systems to achieve desired control functions. Also electrically attached to IR emitter component 130 is an LED flasher 126 and a related resistor 128. LED flasher 126 is primarily used for installation and troubleshooting purposes. More specifically, LED flasher 126 provides a visual indicator that the IR emitter component 130 is operating properly, by providing direct feedback for integrators.

As suggested above, all of these components are carried by an IR transparent circuit board 132. By providing a circuit board to carry the desired components, and to achieve physical and electrical connections necessary for IR emitter device 120, a much more reliable and consistent product can be created. This construction allows for automated manufacturing, and much better quality control (e.g. when compared with an IR emitter simply attached to wires). Utilizing this type of IR transparent circuit board also allows the present IR emitter device 120 device to be positioned directly in front of an IR receiver, while also allowing external IR signals from other sources to be received by the same IR receiver. Due to the transparency of circuit board 132 and other components, IR signals simply pass directly through these structures with only limited (negligible) interference.

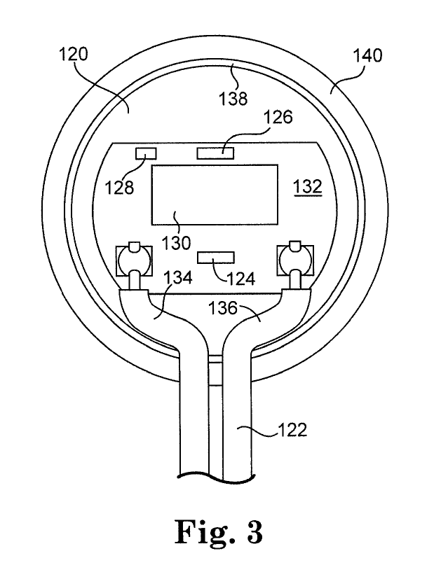

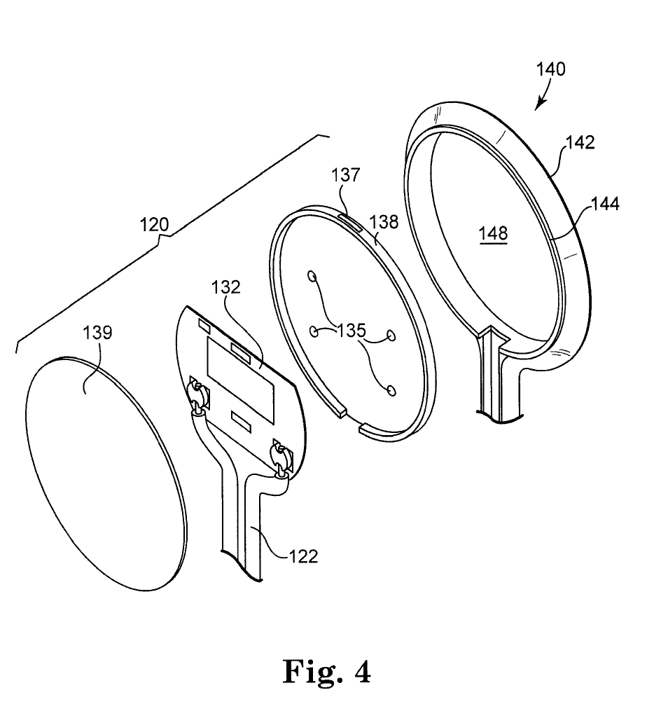

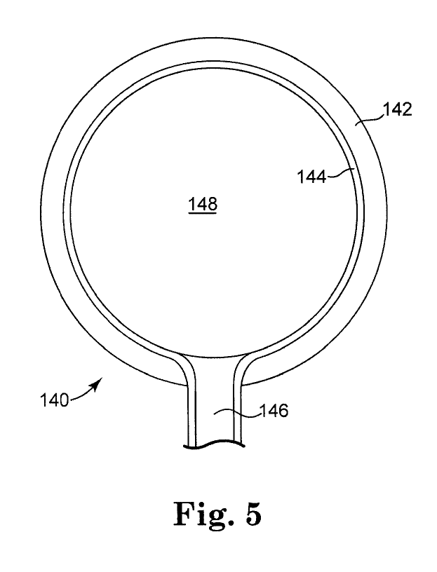

Referring now to FIGS. 3 to 5, various physical structures utilized by the illustrated embodiment of present invention are shown. FIG. 3 illustrates the IR emitter device 120 contained within a holder 140, FIG. 4 shows an exploded view of various components, while FIG. 5 illustrates holder 140 alone. As illustrated in FIG. 3, cable 122 has two wires connected to circuit board 132. A first wire 134 and a second wire 136 are each attached utilizing well-known soldering techniques. Circuit board 132 also carries IR emitter component 130, LED flasher 126, voltage protection resistor 124, and resistor 128. It is anticipated that these are all surface mount components, although other circuit board technologies could easily be used.

Further, a housing 138 is primarily designed to house and contain circuit board 132, while also providing a rigid structure which helps manage cable 122. In actual use, a cover 139 (shown only in FIG. 4) placed over circuit board 132 creates a self-contained housing unit which protects and contains the electrical components of IR emitter device 120. Generally speaking, this cover 139 is disc-shaped and will attach to housing 138 to create a cylindrical structure. Additionally, cover 139 is IR transparent, thus allowing IR signals to pass through this component. Circuit board 132 is generally attached to housing 138 using an adhesive, but could be attached using several well known methodologies. FIG. 4 illustrates adhesive dots 135 as one potential connection methodology.

As further illustrated in FIG. 4, housing 138 includes a small window 137 on one edge thereof. Window 137 is designed and positioned to allow optical signals from LED Flasher 126 to be transmitted out of housing 138. By including window 137, an integrator can allow LED Flasher 126 to be visible by leaving it exposed. Alternatively covering window 137 will not allow signals from LED flasher 126 to be emitted from housing, thus making this component invisible.

Referring now to FIGS. 4 and 5, certain details of holder 140 are better illustrated. As discussed above, holder 140 is primarily designed for easy attachment directly in front of an IR receiver (which is typically integrated into a device or component to be controlled). Consequently, a flexible adhesive film 142 is positioned around an outside portion of a housing structure 144. Housing structure 144 is specifically designed to be a rigid structure capable of being coupled with emitter housing 138 in a removable manner. In this way, IR emitter device 120 can easily be removed while holder 140 remains in place. As further illustrated in FIG. 5, rigid housing 144 includes a cable relief portion 146 which is designed to contain cable 122 and provide physical support therefore. As can be appreciated, this may include appropriate ridges or troughs (not shown) capable of containing cable 122.

As mentioned above, holder 140 includes a flexible film adhesive 142 at an outer portion thereof. Flexible film 142 allows the holder to be attached to many different surfaces, including curved or contoured surfaces. To avoid undesired interference, holder 140 is manufactured from IR transparent materials, thus allowing signals to be easily transmitted there through. The holder 140 also includes an opening 148 centrally located, which generally allows for IR signals to be transmitted to underlying devices and structures. The use of flexible adhesive film 142 provides the holder 140 with considerable flexibility when being installed. Consequently, the holder can be installed in front of most IR receivers as desired, without concern for the shape or configuration of the attachment surface.

Holder 140 can also be manufactured to be either optically transparent or optically opaque. When manufactured to be transparent, IR Emitter device 120 can provide continuous feedback to an integrator. More specifically, optical signals produced by LED flasher 126 will be emitted through window 137 in housing 138, and illuminate holder 140. Alternatively, if holder 140 is optically opaque, the signal from LED flasher 126 will simply be blocked since holder 140 covers window 137. In some cases, it may be beneficial to provide an integrator with both options, thus allowing flexibility when installing the IR emitter device 120.

Those skilled in the art will further appreciate that the present invention may be embodied in other specific forms without departing from the spirit or central attributes thereof. In that the foregoing description of the present invention discloses only exemplary embodiments thereof, it is to be understood that other variations are contemplated as being within the scope of the present invention. Accordingly, the present invention is not limited in the particular embodiments which have been described in detail therein. Rather, reference should be made to the appended claims as indicative of the scope and content of the present invention.

What is claimed is:

1. A transparent IR emitter device positionable directly in front of an IR receiver component, comprising:
an IR transparent circuit board;
an IR signal emitter positioned on a first surface of the circuit board;
a housing supporting the circuit board;
a holder removably coupled to the housing, the holder further having an attachment mechanism to accommodate attachment of the holder at a predetermined position on the IR receiver component, with the IR signal emitter substantially adjacent a receiving surface of the IR receiver component;
an electrical connecting cable electrically coupled to the circuit board and the IR emitter allowing for control of the IR emitter based upon signals received on the electrical connecting cable; and
an IR transparent cover attached to the housing to cover and enclose the circuit board, wherein the IR transparent cover and the IR transparent circuit board are positioned in-line with one another such that IR signals are allowed to pass through the transparent IR emitter.

2. The transparent IR emitter device of claim 1 wherein the circuit board further supports a feedback LED providing an indication that the emitter component is operating properly.

3. The transparent IR emitter device of claim 1 wherein the attachment mechanism is a flexible adhesive film.

4. The transparent IR emitter device of claim 1 wherein the IR emitter component is a surface mount IR emitter.

5. The transparent IR emitter device of claim 1 wherein the housing and holder are coupled to one another using a snap fit connection.

6. The transparent IR emitter device of claim 1 further comprising an input resistor coupled to the circuit board to protect the IR emitter component from overvoltage signals.

7. The transparent IR emitter device of claim 1 wherein the housing further comprises a window positioned adjacent the feedback LED thus allowing the feedback LED to be viewable when energized.

8. An IR emitter device for producing IR signals in response to electrical control signals, comprising:
a holder having a flexible attachment mechanism to accommodate attachment of the holder to a predetermined surface;
a housing configured to be removably coupled to the holder;
an IR emitter component carried by the housing, the IR emitter component producing the IR signals; and
a feedback LED electrically coupled to the IR emitter and carried by the housing for providing a visual indication regarding the operation of the IR emitter.

9. The IR emitter device of claim 8 wherein the IR emitter component and the feedback LED are attached to a circuit board, and wherein the circuit board is supported by the housing.

10. The IR emitter device of claim 9 wherein the circuit board is IR transparent.

11. The IR emitter device of claim 9 wherein the circuit board is configured to accommodate surface-mount connections, and the IR emitter component and the feedback LED are surface-mount electrical components.

12. The IR emitter device of claim 8 wherein the housing further comprises a cover configured to enclose the IR emitter component and the feedback LED within the housing, the housing and circuit board being IR transparent.

13. The IR emitter device of claim 12 wherein the housing further comprises a window at a predetermined position adjacent the feedback LED, thereby allowing the feedback LED to viewed through the window.

14. The IR emitter device of claim 8 wherein the housing further comprises a strain relief structure for supporting an electrical connection wire.

15. The IR emitter device of claim 9 further comprising an electrical connection wire coupled to the circuit board, and wherein the housing further comprises a strain relief structure for supporting the electrical connection wire.

16. An IR emitter device for producing IR control signals in response to received electrical control signals and presenting them to a related IR receiver, the IR emitter device comprising:
a holder having a substantially rigid framework and a flexible attachment structure, the flexible attachment structure configured to allow the holder to be attached to a surface of the IR receiver thereby also holding the rigid structure in close proximity;
a housing removably coupled to the rigid framework of the holder;
a circuit board carried by the housing, the circuit board having an IR emitter component and a feedback LED attached thereto;
a connecting wire electrically coupled to the circuit board and supported by the housing, the electrical wires carrying the electrical control signals to the circuit board, wherein the circuit board causes the electrical control signals to be presented to the IR emitter component thereby producing the IR control signals for presentation to the IR receiver; and
a cover enclosing the housing thus containing the circuit board therein, the housing and the holder configured to be IR transparent thus allowing additional IR control signals to be transmitted to the IR receiver.

17. The IR emitter device of claim 16 wherein the housing is configured to allow the feedback LED to be viewable.

18. The IR emitter device of claim 17 wherein the housing cover and circuit board are IR transparent, thereby allowing any additional IR signals encountered to pass through the IR emitter device without substantial interference.
